(19) United States
(12) Patent Application Publication
(10) Pub. No.: US 2014/0144188 A1
(43) Pub. Date: May 29, 2014

(54) GLASS BASE MATERIAL MANUFACTURING APPARATUS AND METHOD THEREOF

(71) Applicant: SHIN-ETSU CHEMICAL CO., LTD., Tokyo (JP)

(72) Inventors: Junichiro Takei, Gunma-ken (JP); Yuji Tobisaka, Gunma-ken (JP); Hiroshi Machida, Gunma-ken (JP); Hiroyuki Kume, Gunma-ken (JP); Tadakatsu Shimada, Gunma-ken (JP); Kiyoshi Yokokawa, Gunma-ken (JP)

(73) Assignee: SHIN-ETSU CHEMICAL CO., LTD., Tokyo (JP)

(21) Appl. No.: 14/054,571

(22) Filed: Oct. 15, 2013

Related U.S. Application Data
(62) Division of application No. 11/987,538, filed on Nov. 30, 2007, now abandoned.
Application No. 11/987,538 is a division of application No. 10/140,436, filed on May 8, 2002, now abandoned.

(30) Foreign Application Priority Data
May 8, 2001 (JP) 2001-136988
Jun. 7, 2001 (JP) 2001-171961
Jul. 3, 2001 (JP) 2001-202438
Nov. 29, 2001 (JP) 2001-364866
Dec. 27, 2001 (JP) 2001-396363

(51) Int. Cl. C03B 37/014

(52) U.S. Cl. CPC C03B 37/014
USPC 65/421

(57) ABSTRACT

An apparatus for manufacturing a glass base material, which is a base material of an optical fiber, the glass base material having a core rod as a central axis, comprises a holding unit having a plurality of scroll chucks connected in series along the core rod for holding an end of the core rod; and a burner that hydrolyzes a gas material, which is a base material of the glass base material, into glass particles and accumulates the glass particles around the core rod to form the glass base material.

### RELATED APPLICATION

The present application is a divisional of U.S. patent application Ser. No. 11/987,538 filed Nov. 30, 2007 which is a divisional of U.S. patent application Ser. No. 10/140,436 filed May 8, 2002 which claims priority from Japanese patent application Nos. 2001-136988 filed May 8, 2001, No, 2001-171961 filed Jun. 7, 2001, No. 2001-202438 filed Jul. 3, 2001, No. 2001-364866 filed Nov. 29, 2001, and No. 2001-396363 filed Dec. 27, 2001, the contents of which are incorporated herein by reference.

### BACKGROUND OF THE INVENTION

1. Field of the Invention

The present invention relates to a glass base material manufacturing apparatus and a method thereof. More particularly, the present invention relates to a glass base material manufacturing apparatus and a method thereof for manufacturing a high quality glass base material.

2. Description of the Related Art

The glass-base-material was manufactured by such as an outside vapor deposition (OVD) method or a vapor-phase axial deposition (VAD) method. The OVD method accumulates glass particles, which are ejected from a burner, on a surface of a rotated core rod. Conventionally, both ends of the core rod were held by a single scroll chuck and were rotated by rotating the scroll chuck.

A length, a diameter, and a weight of glass base material have been increased in order to increase the productivity of manufacturing an optical fiber. When each end of the core rod was held by a single scroll chuck, it was difficult to hold the core rod firmly by the scroll chuck because the core rod may bend under its own weight, for example. Thus, the core rod may vibrate when the core rod is rotated by the rotation of the scroll chuck. As a result, the glass particles are accumulated around the core rod unequally so that the eccentricity of the manufactured glass base material increases. Thus, the productivity of manufacturing the glass base material decreases.

### SUMMARY OF THE INVENTION

Therefore, it is an object of the present invention to provide a glass base material manufacturing apparatus and a method thereof, which is capable of overcoming the above drawbacks accompanying the conventional art. The above and other objects can be achieved by combinations described in the independent claims. The dependent claims define further advantageous and exemplary combinations of the present invention.

According to the first aspect of the present invention, an apparatus for manufacturing a glass base material, which is a base material of an optical fiber, the glass base material having a core rod as a central axis, comprising a holding unit having a plurality of scroll chucks connected in series along the core rod for holding an end of the core rod; and a burner that hydrolyzes a gas material, which is a base material of the glass base material, into glass particles and accumulates the glass particles around the core rod to form the glass base material.

The holding unit may have a connection plate provided between each scroll chuck in series for connecting each of a plurality of scroll chucks. The connection plate may have a circular shape. The connection plate may include a central hole, through which the core rod is penetrated, and a plurality of bolt holes around a periphery of the connection plate, through which a bolt is penetrated.

Each of the plurality of scroll chucks may include a plurality of bolt holes around a periphery of each plurality of the scroll chucks; and the holding unit may have a plurality of bolts, each of which penetrates through the bolt hole of the scroll chuck and the connection plate for connecting the scroll chucks and the connection plate. The holding unit may have two of the scroll chucks in series along the core rod.

The apparatus may further comprise a core-rod-rotation unit for rotating the core rod around a central axis of the core rod, and the plurality of scroll chucks connected in series hold one longitudinal end of the core rod, which is located closer to the core-rod-rotation unit than another longitudinal end of the core rod. Each of the scroll chucks may have a plurality of jaws, a number of which is an even number more than three, the jaws contacting and holding the core rod. Each of the scroll chucks may have six jaws.

Each of the scroll chucks may have a circular plan shape including a chuck-central-hole formed on a center of the scroll chuck, through which the core rod is penetrated, and the jaws may be provided on the scroll chuck radically in isogonal direction from the chuck-central-hole.

The apparatus may further comprise a chamber having a frame which accommodates the glass base material; a side-burner located inside the frame for heating a longitudinal end of the glass base material; and a position-adjusting unit connected to the side-burner for adjusting a position of the side-burner from outside the frame. The position-adjusting unit may adjust the position of the side-burner by moving the side-burner along a longitudinal direction of the core rod and rotating the side-burner toward the core rod.

The position-adjusting unit may have: a shaft, to which the side-burner is connected; a shaft-rotation handle for rotating the side-burner toward the core rod by rotating the shaft; a slide base, to which the shaft and the shaft-rotation handle are connected; a ball screw for moving the slide base along a longitudinal direction of the core rod; and a horizontal-movement handle which rotates the ball screw to move the slide base along a longitudinal direction of the core rod.

According to the second aspect of the present invention, an apparatus for manufacturing a glass base material, which is a base material of an optical fiber, the glass base material having a core rod as an central axis, comprises a burner that hydrolyzes a gas material, which is a base material of the glass base material, into glass particles and accumulates the glass particles around the core rod to form the glass base material; a chamber which accommodates the core rod and the burner; an air vent formed on a bottom sidewall of the chamber to intake a cleaning gas for cleaning inside the chamber; a filter formed inside the chamber, the filter located lower than the burner and higher than the air vent for regulating a flow speed distribution of the cleaning gas that flows from the air vent; and an air-regulating-plate formed inside the chamber, the air-regulating-plate located lower than the burner and higher than the air vent and having a plurality of holes to regulate a direction of a flow of the cleaning gas that flows from the air vent.

The air-regulating-plate may be formed on an upper side of the filter in the chamber. The filter and the air regulating plate may be located horizontally parallel to longitudinal direction of the core rod. Each of the filter and the air-regulating-plate may cover all over a bottom face of the chamber. The apparatus may further comprise an exhaustion vent formed on a top of the chamber along a longitudinal direction of the core rod for exhausting the cleaning gas existing inside the chamber.

A distance L1 between a bottom surface of the glass base material and the air-regulating-plate may be substantially 140 mm or greater. A distance L1 between a bottom surface of the glass base material and the air-regulating-plate may be substantially 1.25 D or greater when there is a relationship of 1.25 D≧140 mm where D is a diameter of a finished the glass base material. A distance L2 between the air-regulating-plate and the filter may have a relationship of 0≦L2/D≦1.0 where D is a diameter of a finished the glass base material.

According to the third aspect of the present invention, an apparatus for manufacturing a glass base material, which is a base material of an optical fiber, the glass base material having a core rod as a central axis, comprises a burner that hydrolyzes a gas material, which is a base material of the glass base material, into glass particles and accumulates the glass particles around the core rod to form the glass base material; a chamber installed on a floor, the chamber accommodating the core rod and the burner; and a supporting unit formed on a bottom face of the chamber and contacting with the floor for supporting the chamber, the supporting unit comprising a fixed leg fixed on the floor and a plurality of movable legs which are movable with respect to the floor.

The fixed leg may be disposed on the chamber on a center line thereof in at least one of the longitudinal direction and the widthwise direction. The fixed leg may be disposed on the chamber except on a corner of the chamber. The apparatus may further comprise a core-rod-rotation unit for rotating the core rod around a central axis of the core rod, and the core-rod-rotation unit being provided outside the chamber.

According to the fourth aspect of the present invention, a method for manufacturing a glass base material, which is a base material of an optical fiber, the glass base material having a core rod as a central axis, comprises hydrolyzing a gas material, which is a base material of the glass base material, into glass particles; accumulating the glass particles around the core rod to form the glass base material; in taking a cleaning gas into a chamber; regulating a flow speed distribution of the cleaning gas that flows into the chamber by a filter; and regulating a direction of a flow of the cleaning gas that passes through the filter.

The regulating the flow speed distribution and the regulating the direction of the flow may regulate the flow of the cleaning gas to be a laminar flow. The apparatus may further comprise exhausting the cleaning gas from the chamber.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a configuration of a glass-base-material manufacturing apparatus of the present embodiment.

FIG. 2A shows a cross sectional view of the holding unit 14.

FIG. 2B shows a plan view of the holding unit 14.

FIG. 3A shows a detailed cross section of the jaw 60A and the front disk 62A.

FIG. 3B shows a plan view of the connection plate 88. The connection plate 88 has a circular shape.

FIG. 4 shows a detailed configuration of the side-burner 44 and the position-adjusting unit 40.

FIG. 5 shows a perspective view inside the chamber 32 of the present embodiment.

FIG. 6 shows a cross sectional view of the chamber 32 shown in FIG. 5.

FIG. 7 shows a flow of the cleaning gas that flows inside the chamber 32 of the present embodiment.

FIG. 8 shows a flow of the cleaning gas that flows inside the chamber that has the air-regulating-plate 28 but does not have a filter 30.

FIG. 9 shows a flow of the cleaning gas that flows inside the chamber that has the filter 30 but does not have the air-regulating-plate 28.

FIG. 10 shows a plan view of the bottom side of a chamber 32 and the supporting unit 35 of the present embodiment.

FIGS. 11A and 11B show examples of the movable legs 34.

FIG. 12 shows another example of the supporting unit 35.

FIG. 13 shows another example of the supporting unit 35.

### DETAILED DESCRIPTION OF THE INVENTION

The invention will now be described based on the preferred embodiments, which do not intend to limit the scope of the present invention, but exemplify the invention. All of the features and the combinations thereof described in the embodiments are not necessarily essential to the invention.

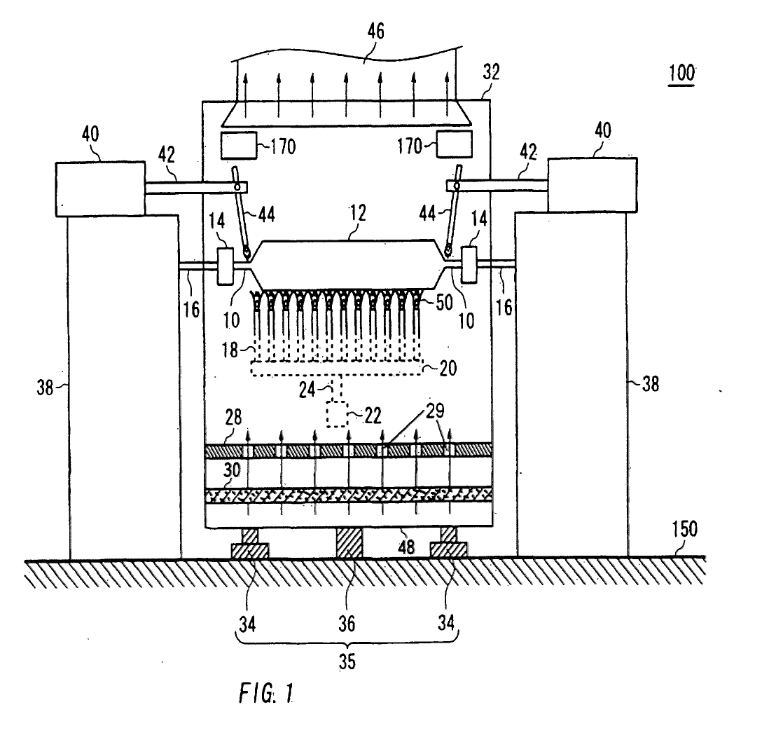

FIG. 1 shows a configuration of a glass-base-material manufacturing apparatus of the present embodiment. The glass-base-material manufacturing apparatus 100 comprises holding units 14, chuck shafts 16, core-rod-rotation units 38, a plurality of burners 18, a burner stage 20, a burner shaft 24, a burner moving unit 22, a filter 30, an air-regulating-plate 28, a chamber 32, a supporting unit 35, an exhaustion vent 46, side-burners 44, side-burner shafts 42, and a position-adjusting unit 40.

The holding units 14 hold each end of a core rod 10. Each of the chuck shafts 16 is connected to each end of the core rod 10 and the corresponding core-rod-rotation unit 38. The core-rod-rotation unit 38 rotates the core rod 10 around the central axis of the core rod 10 by rotating the chuck shaft 16. The core-rod-rotation unit 38 is provided outside the chamber 32. In FIG. 1, the core-rod-rotation unit 38 is provided on both sides of the core rod 10. However, the core-rod-rotation unit 38 may be provided only on one side of the core rod 10.

The plurality of burners 18 hydrolyzes a gas material, which is a base material of the glass base material 12, into glass particles and accumulates the glass particles around the core rod 10 to form a glass base material 12. The plurality of burners 18 is mounted on the burner stage 20. The burner stage 20 is supported by the burner shaft 24. The burner-moving unit 22 moves the burner shaft 24 along a longitudinal direction of the core rod 10 so that the plurality of burners 18 moves along a longitudinal direction of the core rod 10. A part of the bottom side of the burner 18, the burner stage 20, the burner shaft 24, and the burner-moving unit 22, which are shown by the hidden line, are provided outside the chamber 32 to protect the burner-moving unit 22 from the heat inside the chamber 32.

The filter 30 is formed inside the chamber 32. The filter 30 regulates a flow speed distribution of the cleaning gas that flows from the bottom of the chamber 32. The air-regulating-plate 28 is formed on an upper side of the filter 30 in the chamber 32. The air-regulating-plate 28 regulates a direction of a flow of the cleaning gas that passes through the filter 30. The air-regulating-plate 28 has a plurality of holes 29 to regulate a direction of a flow of the cleaning gas. The exhaustion vent 46 exhausts a cleaning gas existing inside the chamber 32. The exhaustion vent 46 is formed on a top of the chamber 32 along a longitudinal direction of the core rod 10.

The chamber 32 accommodates the core rod 10, holding units 14, a plurality of burners 18, a filter 30, and an air-regulating-plate 28. The chamber 32 may be a conventional chamber that has a frame, inner wall, insulation material, and outer wall, which are not shown in FIG. 1. For example, the chamber 32 may be made by welding the inner wall on a frame and further fixing the insulation material and the outer wall on the outer surface of the inner wall in order to prevent the heat inside the chamber 32 to be radiated from the chamber 32.

The shape of the chamber 32 may be box type as shown in FIG. 1, or any other shape that can accommodates the core rod 10 and the burners 18 inside. The material used for the inner wall or outer wall may be stainless steel, or any other material that can stand heating temperature of the burners 18 and can resist reaction gas. Windows 170 are provided on the sidewall of the chamber 32 for checking the position of the side-burner 44 from outside the chamber.

The side-burner 44 heats a longitudinal end of the accumulated glass base material 12. The longitudinal end of the accumulated glass base material 12 is heated to prevent the accumulated glass base material 12 from peeling away from the core rod 10 and causing cracks. The position-adjusting unit 40 adjusts a position of the side-burner 44. The position-adjusting unit 40 is provided outside the chamber 32. For example, in FIG. 1, the position-adjusting unit 40 is provided on the core-rod-rotation unit 38, which is provided outside the chamber 32. However, the position-adjusting unit 40 may be provided on any other place outside the chamber 32.

The supporting unit 35 is formed on a bottom face of the chamber 32. The supporting unit 35 contacts with the floor 150 and supports the chamber 32. The supporting unit 35 has a fixed leg 36, which is fixed on the floor 150, and a plurality of movable legs 34 which are movable with respect to the floor 150.

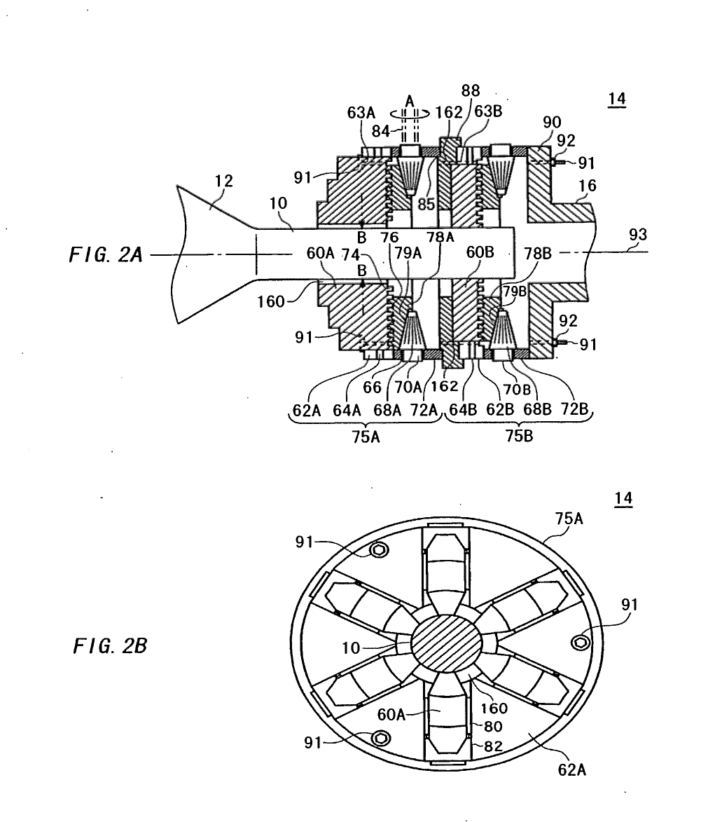

FIG. 2A shows a cross sectional view of the holding unit 14. FIG. 2B shows a plan view of the holding unit 14. As shown in FIG. 2A, the holding unit 14 has a cylindrical shape that rotates around the axial center 93 of the holding unit 14. The holding unit 14 has scroll chucks 75A and 75B, a connection plate 88, a motor-connection-metal-fitting 90, a bolt 91, and a nut 92. In FIG. 2A, the holding unit 14 has two scroll chucks 75A and 75B connected in series along the core rod 10. However, the holding unit 14 may have more than two scroll chucks connected in series. The scroll chucks 75A and 75B are connected in series by the connection plate 88, a bolt 91, and a nut 92. The connection plate 88 is provided between the scroll chucks 75A and 75B.

Each scroll chuck 75A and 75B includes a center hole 160 and a plurality of bolt holes 63A and 63B, respectively, around the center hole 160. The core rod 10 penetrates through the central hole 160 of the scroll chucks 75A and 75B and connection plate 88. The holding unit 14 has a plurality of bolts 91, each of which penetrates through the bolt hole 63A and 63B of the scroll chucks 75A and 75B, bolt holes 162 of the connection plate 88, and a motor-connection-metal-fitting 90 and firmly connects them to be one body. The motor-connection-metal-fitting 90 is connected to the chuck shaft 16, which is connected to the core rod rotation unit 38.

The scroll chuck 75A has jaws 60A, a front disk 62A, a back disk 78A, a cylinder 72A, a bevel gear 68A, and a gear axis 70A. The scroll chuck 75B has a front disk 62B, a back disk 78B, a cylinder 72B, a bevel gear 68B, and a gear axis 70B. The front disk 62A is provided closer to the longitudinal center of the core rod 10 than the back disk 78A. The front disk 62A has a guiding groove 64A, along which the jaws 60A moves.

Each of the jaws 60A has a front spiral groove 74 that swirls to the axial center 93 of the holding unit 14. The back disk 78A has a back spiral groove 76 that swirls to the axial center 93 of the core rod 10. The back spiral groove 76 engages with the front spiral groove 74 of all of the six jaws 60A. Thus, when the back disk 78A rotates around the central axis of the core rod 10, the jaws 60A that engages with the back disk 78A move along the direction perpendicular to longitudinal direction of the core rod 10, as shown by the arrow referred to as “B”.

The cylinder 72A connects the front disk 62A and the connection plate 88. The cylinder 72A is arranged such that the axial center of the cylinder 78A is identical with the axial center 93 of the holding unit 14. The cylinder 72A has six penetration holes 66, through which each of the gear axis 70A penetrates. The diameter of the penetration hole 66 is smaller than the diameter of the bottom part of the bevel gear 68A. Each of the six bevel gears 68A is connected to the corresponding gear axis 70A. The gear axis 70A are arranged such that the direction of the gear axis 70A is parallel to the moving direction of the jaws 60A, shown by the arrow “B”. In other words, the longitudinal direction of the gear axis 70A is perpendicular to longitudinal direction of the core rod 10.

The back disk 78A has cogs 79 on an opposite side of the back spiral groove 76 that engage with the bevel gear 68A. Thus, the bevel gear 68A can rotate the back disk 78A around the axial center 93 of the holding unit 14 by rotating around the gear axis 70A. The gear axis 70A may be rotated manually by the hexagonal wrench 84 or rotated automatically by a motor, not shown in the figures.

By rotating the gear axis 70A and 70B with a hexagonal wrench 84 in the direction shown by the arrow referred to as “A”, the back disks 78A and 78B, each of which engages with the bevel gears 68A and 68B, are rotated around the axial center 93 of the holding unit 14. Then, the six jaws 60A and 60B, each of which engages with the back disks 78A and 78B, move closer to the core rod 10 in the direction shown by the arrow “B” along the guiding grooves 64A and 64B and finally hold the core rod 10.

The configuration of the scroll chuck 75B is the same with that of the scroll chuck 75A except the thickness of the jaw 60B in the longitudinal direction of the core rod 10 is thinner than that of the scroll chuck 75A and the cylinder 72B connecting the front disk 64B and the motor-connection-metal-fitting 90. Thus, the explanation of the scroll chuck 75B is abbreviated.

Referring to FIG. 2B, the scroll chuck 75A has a circular plan shape including a central hole 160 formed on a center of the scroll chuck 75A, through which the core rod 10 is penetrated. The front disk 62A has six radial cuts 82 formed radially and isogonally from the central hole 160. The scroll chuck 75A has six jaws 60A. Each of the six jaws 62A is provided in the radial cut 82. Thus, the six jaws 60A are provided radially and isogonally from the central hole 160. The angle between each of the jaws 60A is substantially 60 degrees. Thus, the scroll chuck 75A can hold the circumference of the core rod 10 with equal pressure by the jaws 60A.

If the number of jaws is three, it is difficult to hold the core rod such that the axial center of the core rod becomes the same with the axial center of the holding unit 14, which is the same with the center of the central hole 160. That is, jaws begin the holding process before the pressure applied to the core rod 10 by the jaws becomes equal for each jaw. Thus, the scroll chuck may hold the core rod 10 such that the axial center of the core rod 10 does not match with the axial center of the scroll chuck.

If the scroll chuck has an odd number of jaws, such as five, seven, and so on, the scroll chuck tends to hold the core rod such that the axial center of the core rod 10 does not match with the axial center of the scroll chuck. Thus, the scroll chuck of the present embodiment has even number of jaws more than three.

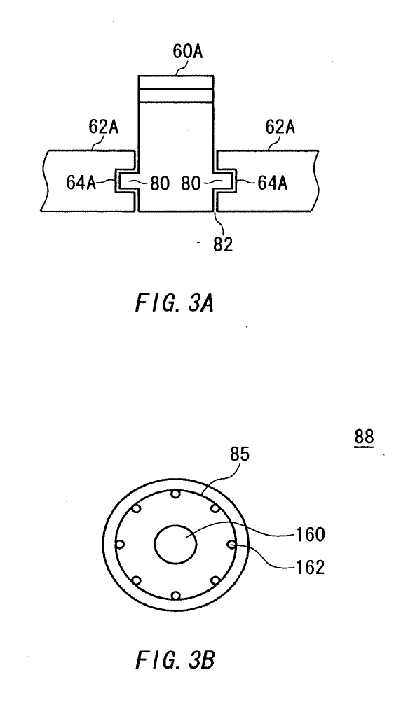

FIG. 3A shows a detailed cross section of the jaw 60A and the front disk 62A. The jaw 60A has convex parts 80 on both side ends of the jaw 60A. Furthermore, the convex part 80 of the jaw 60A engages with the guiding grooves 64A of the front disk 62A. Thus, the jaw 60A moves along the guiding grooves 64A of the front disk 62A. The jaw 60B and the front disk 62B also have the same configuration with that of the jaw 60A and the front disk 62A.

FIG. 3B shows a plan view of the connection plate 88. The connection plate 88 has a circular shape. The connection plate 88 includes a central hole 160, through which the core rod 10 can penetrate. A plurality of bolt holes 162 is formed around the central hole 160 of the connection plate 88. Furthermore, as shown in FIG. 2A and FIG. 3B, the front side of the connection plate has step 85, to which the longitudinal end of the cylinder 72A engages.

Because the holding unit 14 has a plurality of scroll chucks 75A and 75B connected in series, the holding unit 14 can firmly hold the core rod 10 so that the core rod 10 does not vibrate when the core rod 10 rotates. Furthermore, because each scroll chuck 75A and 75B has six jaws 60A and 60B, the scroll chucks 75A and 75B can firmly hold the core rod 10 so that the core rod 10 does not vibrate when the core rod 10 rotates. Therefore, the glass base material manufacturing apparatus 100 of the present embodiment can manufacture a high quality glass base material 12, the axial center of core rod 10 of which positions accurately at the axial center of the glass base material 12.

Furthermore, because each scroll chuck 75A and 75B has isogonally arranged six jaws 60A and 60B, the stress applied on the core rod 10 by each of the jaws 60A and 60B is smaller than the stress applied on the core rod 10 by the scroll chuck having jaws, the number of which is smaller than six.

Also, because the number of jaws 60A and 60B are even numbers of six, and the jaws 60A and 60B are arranged isogonal with the center hole 160 of the front disk 62A and 62B, the stress applied on the core rod 10 by the jaws 60A and 60B is substantially equal. In other words, the holding unit 14 can hold the core rod 10 such that the axial center of the core rod becomes the axial center 93 of the holding unit 14. Thus, the core rod 10 does not vibrate when the core rod 10 rotates. Therefore, a crack does not occur on the core rod 10 and the glass base material 12 during holding and rotating the core rod 10 by the scroll chuck.

The holding unit 14 of the present embodiment may be provided on both sides of the core rod 10. Also, the holding unit 14 of the present embodiment may be provided only on one end of the core rod 10, and a holding unit, which has a single scroll chuck, may be provided on another end of the core rod 10. In this case, if the apparatus 100 has only one holding unit 14 of the present embodiment and has only one core-rod-rotation unit 38, the holding unit 14 of the present embodiment is provided on the end of the core rod 10, which is located closer to the core-rod-rotation unit 38 than the other end of the core rod 10.

The use of the holding unit 14 of the present embodiment is not limited to the OVD method as shown in FIG. 1, but the holding unit 14 can be used for the VAD method for holding a core rod 10. Furthermore, the use of the holding unit 14 is not limited to the glass base manufacturing apparatus. The holding unit 14 shown in FIG. 2A-3B may be used for an apparatus that polishes the surface of the glass base material 12 with a flame. Also, the holding unit 14 may be used for an apparatus that elongates the glass base material 12.

### Example 1

One end of the core rod 10 was held by the holding unit 14 of the present embodiment, and another end of the core rod was held by the holding unit 14 having a single scroll chuck. The diameter of the core rod 10 was 50 mm, and the length of the core rod 10 was 3 m. The amount of vibration of the core rod 10 during holding and rotating the core rod 10 by the holding unit 14 was 0.2 mm, which was smaller than that of the conventional holding unit.

Furthermore, the eccentricity of the glass base material manufactured by the apparatus 100 of the present embodiment was 0.1 which was smaller than the eccentricity of the glass base material manufactured by the conventional apparatus. Furthermore, the eccentricity of the optical fiber drawn from the glass base material manufactured by the present apparatus 100 of the present embodiment was 0.1%, which was smaller than the eccentricity of the optical fiber drawn from the glass base material manufactured by the conventional apparatus.

### Comparative Example 1

Both ends of the core rod 10, which was the same as the core rod 10 used in EXAMPLE 1, were held by the holding unit having a single scroll chuck. The amount of vibration of the core rod 10 during holding and rotating the core rod 10 by the holding unit was 0.4 mm, which was larger than that of the holding unit 14 of the present embodiment.

Furthermore, the eccentricity of the glass base material manufactured by the conventional apparatus was 0.2%, which was larger than the eccentricity of the glass base material manufactured by the apparatus 100 of the present embodiment. Furthermore, the eccentricity of the optical fiber drawn from the glass base material manufactured by the conventional apparatus was 0.2%, which was larger than the eccentricity of the optical fiber drawn from the glass base material manufactured by the apparatus 100 of the present embodiment.

### Example 2

A glass base material was manufactured by the OVD method using the apparatus 100 of the present embodiment, which had a holding unit 14 that included a scroll chuck 75 having six jaws 60. First, both ends of a core rod 10, which had a 50 mm diameter and 3000 mm length, was held by the scroll chuck 75 having six jaws 60. The holding units 14 held the core rod 10 in the horizontal direction and rotated the core rod 10 around the axial center of the core rod 10. Then, the glass particles were ejected from the burners 18 and accumulated around the surface of the core rod 10. The amount of vibration of core rod 10 during holding and rotating the core rod 10 by the holding unit 14 was 0.2 mm in average value, which was smaller than that of the conventional holding unit.

Furthermore, the eccentricity of the glass base material manufactured by the apparatus 100 of the present embodiment was 0.1%, which was smaller than the eccentricity of the glass base material manufactured by the conventional apparatus. Furthermore, the eccentricity of the optical fiber drawn from the glass base material manufactured by the apparatus 100 of the present embodiment was 0.1%, which was smaller than the eccentricity of the optical fiber drawn from the glass base material manufactured by the conventional apparatus.

### Comparative Example 2

A glass base material was manufactured by the OVD method using the conventional apparatus, which has a holding unit that includes a scroll chuck having three jaws. Other conditions were the same as EXAMPLE 2. The amount of vibration of the core rod 10 during holding and rotating the core rod 10 by the holding unit was 0.4 mm in average value, which was larger than that of the holding unit 14 of the present embodiment.

Furthermore, the eccentricity of the glass base material manufactured by the conventional apparatus was 0.2%, which was larger than the eccentricity of the glass base material manufactured by the apparatus 100 of the present embodiment. Also, the eccentricity of the optical fiber drawn from the glass base material manufactured by the conventional apparatus was 0.2%, which was larger than the eccentricity of the optical fiber drawn from the glass base material manufactured by the apparatus 100 of the present embodiment.

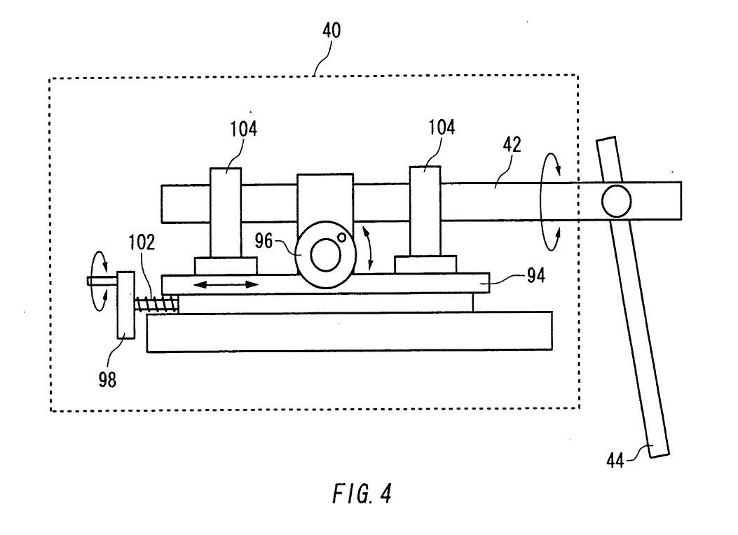

FIG. 4 shows a detailed configuration of the side-burner 44 and the position-adjusting unit 40. The side-burner 44 heats the longitudinal end of the glass base material 12. By heating the longitudinal end of the glass base material 12, the density of the glass particles accumulated on the longitudinal end of the glass base material 12 increases. Therefore, the process of heating the longitudinal end of the core rod can prevent the crack and the breakage of the core rod 10 at the longitudinal end of the glass base material 12 caused by the residual stress. Thus, the periphery of the border between the accumulated layer of the glass particles and the core rod 10 is heated by the side-burner 44.

To heat the appropriate position of the glass base material by the side-burner 44, the position-adjusting unit 40 adjusts the position and angle of the side-burner 44 toward the glass base material 12. The position-adjusting unit 40 has a shaft 42, bearings 104, a shaft-rotation handle 96, a slide base 94, a ball screw 102, and a horizontal-movement handle 98.

The side-burner 44 is connected to the shaft 42. The shaft 42 is supported by the bearings 104 such that the shaft 42 can rotate inside a hole formed in the bearing 104. The shaft-rotation handle 96 rotates the side-burner 44 around the axis of the shaft 42. Thus, the shaft-rotation handle 96 can adjust the angle of the side-burner 44 toward the core rod 10 by rotating the shaft 42.

The shaft 42, bearings 104, and the shaft-rotation handle 96 are installed on the slide base 94. The horizontal-movement handle 98 is connected to the ball screw 102. Thus, when the horizontal-movement handle 98 rotates, the ball screw 102 rotates. The slide base 94 moves in a longitudinal direction of the shaft 42 by rotating the horizontal-movement handle 98. Thus, the shaft 42, bearings 104, and the shaft-rotation handle 96 move in the horizontal direction together with the slide base 94. Therefore, the position-adjusting unit 40 can adjust the position and angle of the side-burner 44 by rotating the shaft-rotation handle 96 and the horizontal-movement handle 98.

Referring to FIG. 1, the chamber 32 has windows 170 on the sidewall. Because the position-adjusting unit 40 is provided outside the chamber 32, the position and angle of the side-burner can be easily adjusted during manufacturing the glass base material 12 by checking the position of the glass base material 12 inside the chamber 32 from the windows 170 and changing the position of the side-burner 44 using the position-adjusting unit 40 from outside the chamber 32.

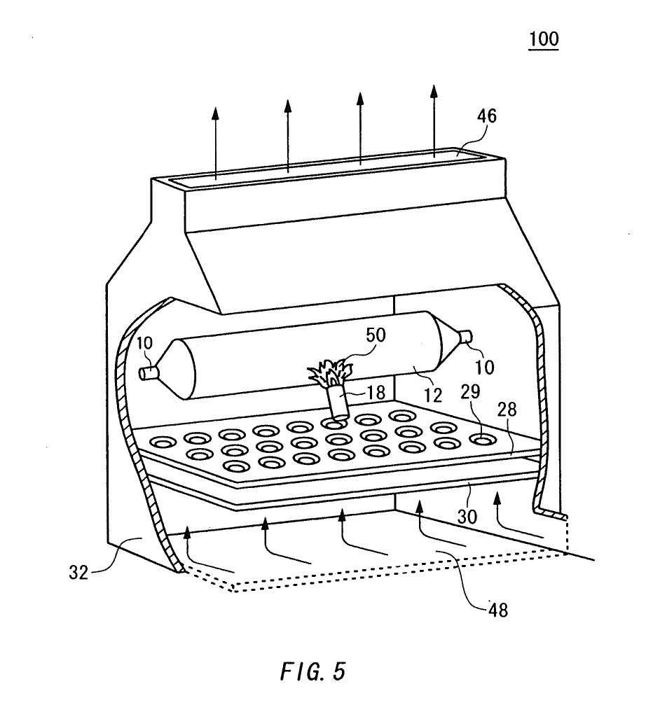

FIG. 5 shows a perspective view inside the chamber 32 of the present embodiment. The chamber 32 has an air vent 48 on a bottom sidewall of the chamber 32 to intake a cleaning gas that cleans inside the chamber 32. The cleaning gas flows upwards in the chamber 32 to move the glass particles, which are not accumulated on the core rod 10, outside the chamber 32 from the exhaustion vents 46. As examples of the cleaning gas, these can be air, inert gas such as argon gas and helium gas, oxygen gas, and so on.

The filter 30 is formed inside the chamber 32 near the bottom end of the chamber 32 and above the air vent 48 to intake the air that flows from the air vent 48. The filter 30 regulates a flow speed distribution of the cleaning gas that flows from the bottom of the chamber 32. The air-regulating-plate 28 is formed on an upper side of the filter 30 in the chamber 32. However, the air-regulating-plate 28 may be formed on a lower side of the filter 30 in the chamber 32.

The air-regulating-plate 28 has a plurality of holes 29. The air-regulating-plate 28 regulates the direction of the flow of the cleaning gas that passed through the filter 30 by the plurality of holes 29. The filter 30 and the air-regulating-plate 28 are arranged horizontally parallel to the longitudinal direction of the core rod 10. The filter 30 and the air-regulating-plate 28 cover all over a bottom face of the chamber 32.

The air-regulating-plate 28 can regulate and change the direction of the flow of the cleaning gas that flows inside the chamber 32. However, it is difficult to prevent the unevenness of the flow speed distribution of the cleaning gas occurring locally only by the air-regulating-plate 28. On the other hand, the filter can prevent the unevenness of the flow speed distribution of the cleaning gas. However, it is difficult to regulate and change the direction of the flow of the cleaning gas only by the filter 30. Thus, the present embodiment uses both the air-regulating-plate 28 and the filter 30 to regulate the flow of the cleaning gas to be a laminar flow.

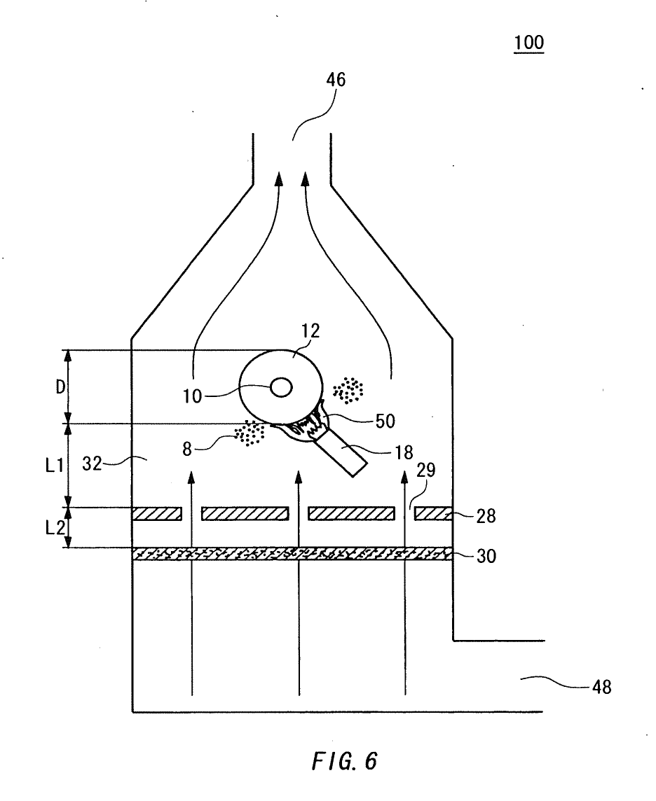

FIG. 6 shows a cross sectional view of the chamber 32 shown in FIG. 5. If there are glass particles 8, which are not accumulated on the core rod 10 and floated inside the chamber 32, these glass particles 8 may contact again with the core rod 10 while floating inside the chamber 32. The glass particles 8 also may attach or accumulate on the inside wall of the chamber 32 and contact again with the core rod 10 when the glass particles 8 peel and fall from the wall of the chamber 32 because of the increase of the weight of the accumulated glass particles 8.

When the glass base material 12, on which the floated glass particles 8 are attached, is sintered and vitrified to form a preform, a bubble is generated from the re-attached glass particles 8 as a nucleus. If the glass base material 12 contains a bubble, the optical fiber drawn from this glass base material 12 may be broken at the position of the bubble. Thus, the glass particles 8 floated inside the chamber 32 are removed from the chamber 32 by the cleaning gas.

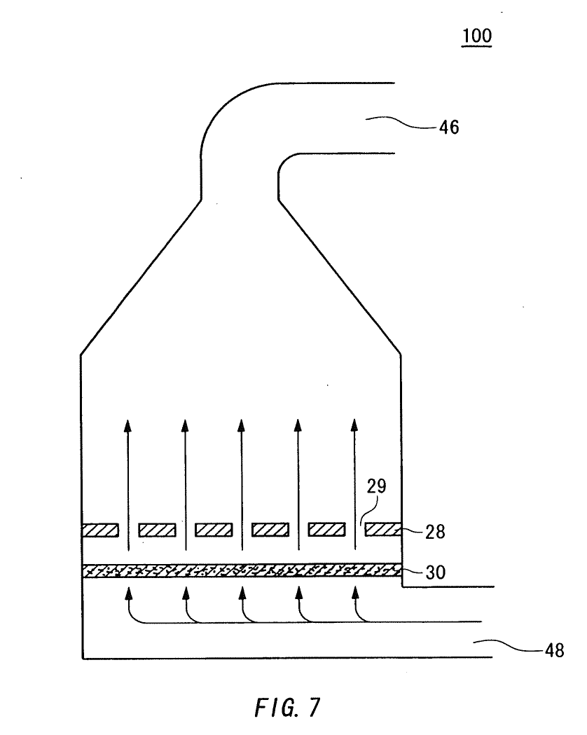

The air-regulating-plate 28 and the filter 30 regulate the direction and speed of the flow of the cleaning gas to be a laminar flow, which has multiple layers flowing parallel to each other as shown in FIG. 7. The cleaning gas flows upward from the air vent 48 and is exhausted from the exhaustion vent 46. By regulating the flow of the cleaning gas to be laminar flow over the whole length of the core rod 10, the generation of a vortex flow or a backward flow of cleaning gas inside the chamber 32 can be prevented.

Thus, the glass particles that float inside the chamber 32, which are not accumulated on the core rod 10, can be removed from the chamber 32 so that the floated glass particles do not attach to the core rod 10 again or do not attach to the inner wall of the chamber 32. Furthermore, the present embodiment can prevent the floated glass particles, which are accumulated on the inner wall of the chamber 32 and fall from the inner wall of the chamber 32, to attach to the core rod 10 again.

The distance L1 between the bottom surface of the glass base material 12 and the air-regulating-plate 28 is substantially 140 mm or greater. When the diameter of the finished glass base material 12 is referred to as “D”, and when there is a relationship of 1.25 D≧140 mm, the distance L1 is substantially 1.25 D or greater. When the above mentioned relationship is satisfied, the laminar flow of the cleaning gas can be easily obtained. Furthermore, the flow of the cleaning gas can be easily regulated to be laminar flow when the relationship of 0≦L2/D≦1.0 is satisfied where L2 denotes the distance between the air-regulating-plate 28 and the filter 30.

### Example 3

FIG. 7 shows a flow of the cleaning gas that flows inside the chamber 32 of the present embodiment. The core rod 10 and the burner 18 are excluded from FIG. 7 to simplify the explanation. A glass base material 12 was manufactured using the apparatus of the present embodiment shown in FIG. 7. As shown in FIG. 7, because the air-regulating-plate 28 and the filter 30 regulated the direction and the speed distribution of the flow of the cleaning gas, the flow of the cleaning gas inside the chamber 32 became laminar flow over the whole length of the core rod 10. The cleaning gas, which passed through the filter 30 and the air-regulating-plate 28, flowed upward and was exhausted from the exhaustion vent 46 outside the chamber 32.

Then, the glass base material 12 manufactured by the apparatus of the present embodiment is sintered and vitrified to form a preform. The manufactured preform had less bubbles than the preform manufactured by the conventional apparatus that did not have the filter 30 and the air-regulating-plate 28.

### Comparative Example 3

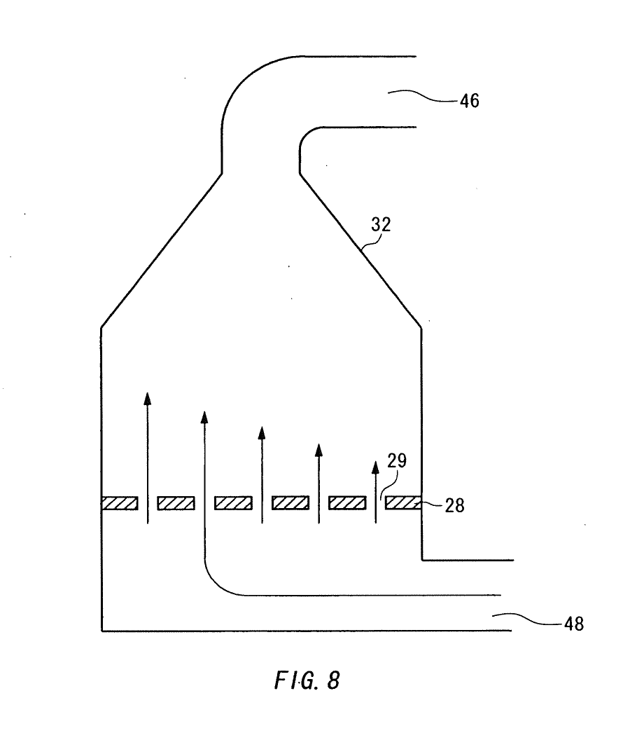

FIG. 8 shows a flow of the cleaning gas that flows inside the chamber that has the air-regulating-plate 28 but does not have a filter 30. A glass base material 12 was manufactured using the apparatus shown in FIG. 8. As shown in FIG. 8, the cleaning gas flowing into the chamber 32 became the laminar flow by the air-regulating-plate 28. However, because the apparatus does not have the filter 30, the speed distribution of the flow of the cleaning gas became uneven to generate a vortex flow. Thus, the glass particles floated and remained inside the chamber 32 and could not be removed.

Then, the glass base material 12 manufactured by the apparatus shown in FIG. 8 is sintered and vitrified to form a preform. The manufactured preform had a greater numbers of bubbles, which are created from the floated glass particles as nuclear, than the numbers of bubbles of the preform, which is formed from the glass base material manufactured by the apparatus 100 of the present embodiment.

### Comparative Example 4

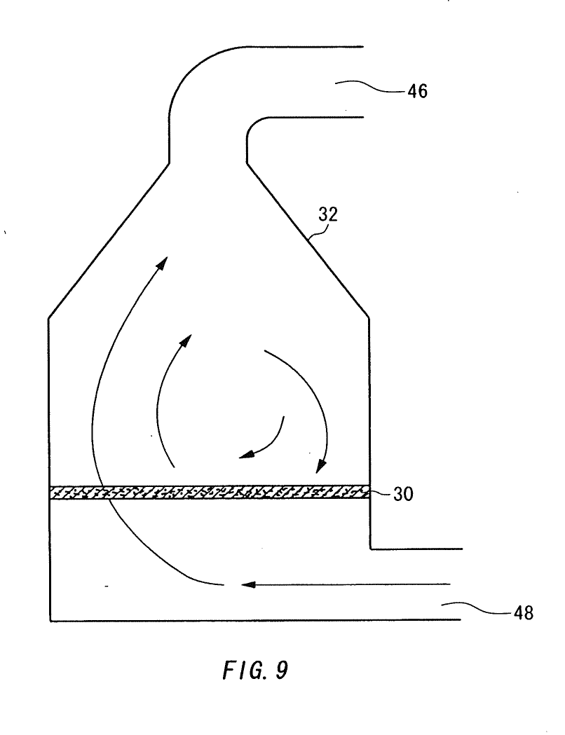

FIG. 9 shows a flow of the cleaning gas that flows inside the chamber that has the filter 30 but does not have the air-regulating-plate 28. A glass base material 12 was manufactured using the apparatus shown in FIG. 9. As shown in FIG. 9, the cleaning gas flows into the chamber 32 to form the convex flow. Thus, the glass particles, which were floating and remained inside the chamber 32, attached to the core rod 10.

Then, the glass base material 12 manufactured by the apparatus shown in FIG. 9 is sintered and vitrified to form a preform. The manufactured preform had a greater number of bubbles, which were created from the floated glass particles as nuclear, than the number of bubbles in the preform formed by the glass base material manufactured by the apparatus 100 of the present embodiment.

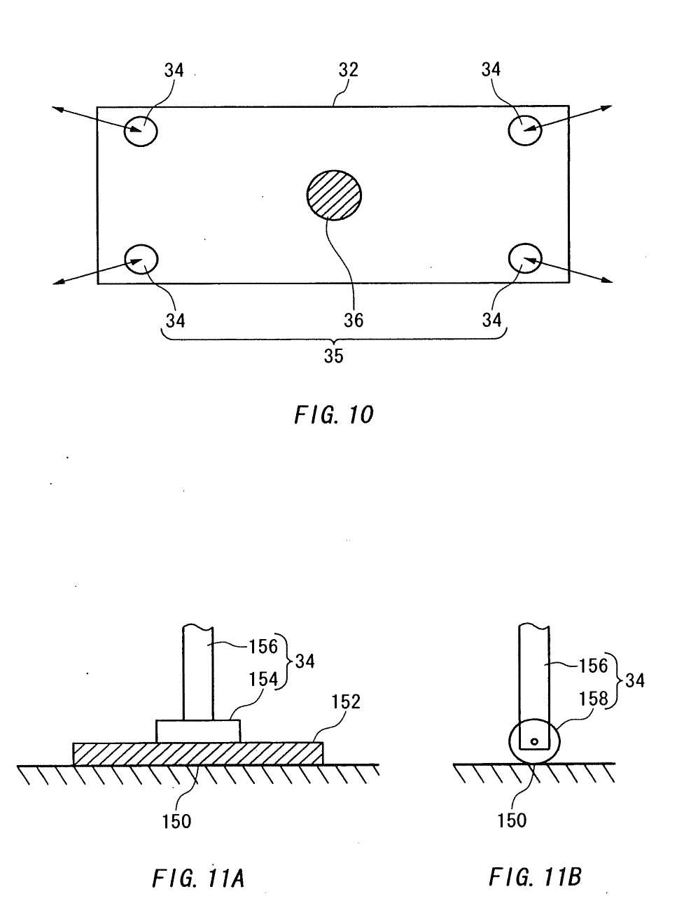

FIG. 10 shows a plan view of the bottom side of a chamber 32 and the supporting unit 35 of the present embodiment. As shown in FIGS. 1 and 10, the supporting unit 35 has a fixed leg 36 fixed on the floor 150 and a plurality of movable legs 34 which are movable with respect to the floor 150. The fixed leg 36 is disposed on the chamber 32 except on a corner of the chamber 32. Specifically, the fixed leg 36 is disposed on the chamber 32 on a centerline thereof in at least one of the longitudinal direction and the widthwise direction.

FIGS. 11A and 11B show examples of the movable legs 34. In FIG. 11A, a metal plate 152 is mounted on the floor 150, and the movable leg 34 is placed on a metal plate 152. The movable leg 34 has a supporting shaft 156 and a supporting plate 154, which is fixed on the supporting shaft 156. Grease is applied on the metal plate 152 so that the movable leg 34 can slide on the metal plate 152, the surface of which is smooth. Also, as shown in FIG. 11B, the movable legs 34 may have a wheel or roller 158 that rotates on the floor 150.

During the manufacturing process of the glass base material 12, temperature in the chamber 32 increases by the heat generated by the burners 18. Especially, when there is a plurality of burners 18 in the chamber 32 as shown in FIG. 1, the heat generated inside the chamber 32 becomes intense. Also, the burners 18 move only a limited region along the longitudinal direction of the core rod 10 when there is a plurality of burners 18. Thus, the burner 18 exists at the specific region in the chamber 32. Therefore, the temperature of the specific region, where the chamber 32 receives the heat of the burners 18, increases.

Because the heat increases inside the chamber 32 by the burners 18, the size of the chamber 32 expands. If all the legs are fixed on the floor 150, the chamber 32 may be distorted or broken owing to the stress caused by the expansion of the chamber 32. Thus, the present embodiment has a fixed leg 36 and a plurality of movable legs 34 to remove the stress caused by the expansion of the chamber 32.

In FIG. 10, the fixed leg 36 is disposed on substantially the centerline of both the longitudinal direction and the widthwise direction of the bottom of the chamber 32. The movable legs 34 are disposed on each of the corners of the bottom of the chamber 32. As shown in FIG. 10, when the chamber expands by the heat inside chamber 32, the movable legs 34 move radially from the fixed leg 36 as the center in the direction shown by the arrows. Thus, the heat expansion is dispersed in the radial direction shown by the arrows. Therefore, the stress caused by the heat expansion of the chamber 32 is removed by the radial movement of the movable legs 34. Thus, the supporting unit 35 of the present embodiment can prevent the permanent deformation or damage of the chamber 32.

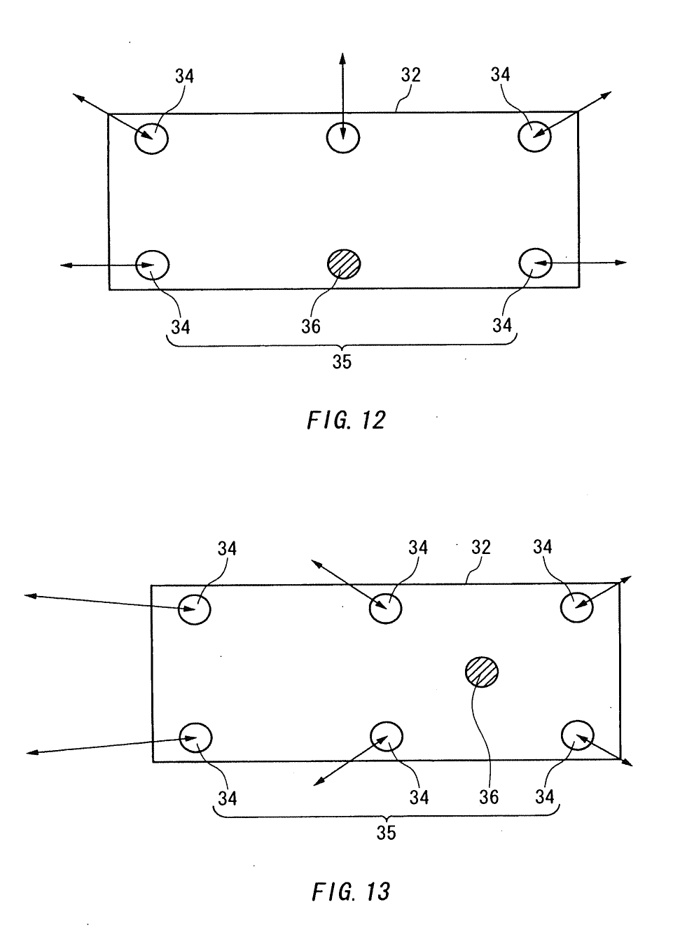

The configuration of the movable legs 34 is not limited to FIGS. 11A and 11B, but may be any configurations that can move in the direction of the heat expansion of the chamber 32. The movement of the movable legs 34 may be limited in the height direction to prevent the chamber 32 from overturning. The number of movable legs 34 may be four as shown in FIG. 10, five as shown in FIG. 12, or six as shown in FIG. 13. The number of movable legs 34 is determined according to the size of the chamber 32.

FIG. 12 shows another example of the supporting unit 35. The fixed leg 36 is disposed on the chamber 32 on a centerline thereof in the longitudinal direction of the chamber 32 and close to the end of chamber in the widthwise direction. The movable legs 34 are provided on five locations. Four movable legs are disposed on the corners of the chamber 32, and one movable leg 34 is disposed on the centerline of the chamber 32 in the longitudinal direction of the chamber 32 and close to the end of chamber 32 in the widthwise direction, which is the opposite side of the fixed leg 36. The movable legs 34 move from the fixed leg 36 as a center in the direction shown by the arrow according to the increase of the size of the chamber 32. Thus, the stress caused by the heat expansion can be removed by the present embodiment.

FIG. 13 shows another example of the supporting unit 35. The fixed leg 36 is disposed on the chamber 32 on a centerline thereof in the widthwise direction of the chamber 32 and located to the right-hand side of the chamber 32 in the longitudinal direction in FIG. 13. The movable legs 34 are provided on the six locations of the corners and the end part in the widthwise direction of the chamber 32. The movable legs 34 move from the fixed leg 36 as a center in the direction shown by the arrow, especially in the left direction according to the increase of the size of the chamber 32. Thus, the stress caused by the heat expansion can be removed by the present embodiment.

The core-rod-rotation unit 38 is provided outside the chamber 32 in order to prevent the distance between the holding units 14 to be changed by the heat expansion of the chamber 32, which may cause the breakage of the glass base material 12.

### Example 4

A glass base material was manufactured using the apparatus shown in FIG. 10. The supporting unit 35 shown in FIG. 11A was used. The fixed leg 36 was fixed on the floor 150 by an anchor, not shown in the figures. A metal plate 152 having a thickness of 30 mm was mounted on the floor 150. The area of the metal plate 152 was greater than the area of the supporting plate 154. Grease was applied on the surface of the metal plate 152. Then, the movable legs 34 were mounted on the metal plate 152. The metal plate 152 mounted on the floor 150 is fixed on the floor 150 by the anchor.

The size of the chamber 32 was 3.5 m in width, 2 m in length, and 1.5 m in depth. The chamber 32 has an opening for burners 18 and an opening for exhaustion.

The condition of raw material gas supplied to the burner 18 was 50 Nl/min per burner of hydrogen gas (H₂), 30 Nl/min per burner of oxygen gas (O₂), and 3.5 g/min per burner of raw material gas of silicon chloride (SiCl₄) at the initial stage of the accumulation of the glass particles on the core rod 10. Furthermore, the condition of raw material gas supplied to the burner 18 was adjusted to be 100 Nl/min per burner of hydrogen gas (H₂), 50 Nl/min per burner of oxygen gas (O₂), and 23 g/min per burner of raw material gas of silicon chloride (SiCl₄) according to the growth of the glass base material 12 at an end of the accumulation of the glass particles.

The burner-moving unit 22 had a high-speed axis and a low-speed axis to move the burner shaft 24. The high-speed axis moves the burner shaft 24 with high speed, and the low-speed axis moves the burner shaft 24 with a speed lower than the high-speed axis. The high-speed axis was moved with the speed of 1000 mm/min, and the low-speed axis was moved with the speed of 20 mm/min. The moving distance of both the high-speed axis and the low-speed axis was 150 mm. 10 burners 18 were mounted on the burner stage 20 at 150 mm intervals. The distance between the burners 18 and the glass base material 12 was controlled to be constant during the accumulation process.

The condition of the chamber 12 was observed during the accumulation process. The temperature inside the chamber 32 during the accumulation process was almost the same as the conventional chamber. However, no strain was observed on the inner wall of the chamber 32 after the end of the accumulation process. The amount of deformation of the chamber 32 was measured by measuring the amount of movement of the movable leg 34. The amount of movement of the movable leg 34 was 10 mm. Therefore, the stress caused by the heat expansion of the chamber 12 was removed by the movable legs 34.

### Comparative Example

A glass base material was manufactured using a chamber that has a supporting unit including legs, all of which were fixed on the floor by an anchor. The glass base material was manufactured according to the same condition with that of EXAMPLE 4 except the configuration of the supporting unit.

The condition of the chamber was observed during the accumulation process. The temperature was increased over 300° C. inside the chamber 32 during the accumulation process. There was strain in the inner wall of the chamber 32 after the end of the accumulation process because the stress caused by the heat expansion could not escape. The strain was greater at the center part of the chamber 32 than the strain at the other parts.

As explained above, the apparatus 100 of the present embodiment can select the direction, to which the stress caused by the heat expansion is removed, by selecting the position of the fixed leg 36 and the movable legs 34 on the chamber 32. The position of the fixed leg 36 on the chamber 32 may be determined according to the location of the chamber 32 in the factory, equipment provided around the apparatus 100, a working space, and so on.

Although the present invention has been described by way of exemplary embodiments, it should be understood that those skilled in the art might make many changes and substitutions without departing from the spirit and the scope of the present invention which is defined only by the appended claims.

What is claimed is:

1. An apparatus for manufacturing a glass base material, which is a base material of an optical fiber, said glass base material having a core rod as a central axis, comprising:
a holding unit having a plurality of scroll chucks connected in series along said core rod for holding an end of said core rod; and
a burner that hydrolyzes a gas material, which is a base material of said glass base material, into glass particles and accumulates said glass particles around said core rod to form said glass base material.

2. An apparatus as claimed in claim 1, wherein said holding unit has a connection plate provided between each scroll chuck in series for connecting each of a plurality of scroll chucks.

3. An apparatus as claimed in claim 2, wherein said connection plate has a circular shape, said connection plate including a central hole, through which said core rod is penetrated, and a plurality of bolt holes around a periphery of said connection plate, through which a bolt is penetrated.

4. An apparatus as claimed in claim 3, wherein:
each of said plurality of scroll chucks includes a plurality of bolt holes around a periphery of each plurality of said scroll chucks; and
said holding unit has a plurality of bolts, each of which penetrates through said bolt hole of said scroll chuck and said connection plate for connecting said scroll chucks and said connection plate.

5. An apparatus as claimed in claim 1, wherein said holding unit has two of said scroll chucks in series along said core rod.

6. An apparatus as claimed in claim 1, further comprising a core-rod-rotation unit for rotating said core rod around a central axis of said core rod, and said plurality of scroll chucks connected in series hold one longitudinal end of said core rod, which is located closer to said core-rod-rotation unit than another longitudinal end of said core rod.

7. An apparatus as claimed in claim 1, wherein each of said scroll chucks has a plurality of jaws, a number of which is an even number more than three, said jaws contacting and holding said core rod.

8. An apparatus as claimed in claim 7, wherein each of said scroll chucks has six jaws.

9. An apparatus as claimed in claim 7, wherein each of said scroll chucks has a circular plan shape including a chuck-central-hole formed on a center of said scroll chuck, through which said core rod is penetrated, and said jaws are provided on said scroll chuck radically in isogonal direction from said chuck-central-hole.

10. An apparatus as claimed in claim 1, further comprising:
a chamber having a frame which accommodates said glass base material;
a side-burner located inside said frame for heating a longitudinal end of said glass base material; and
a position-adjusting unit connected to said side-burner for adjusting a position of said side-burner from outside said frame.

11. An apparatus as claimed in claim 10, wherein said position-adjusting unit adjusts said position of said side-burner by moving said side-burner along a longitudinal direction of said core rod and rotating said side-burner toward said core rod.

12. An apparatus as claimed in claim 11, wherein said position-adjusting unit has:
a shaft, to which said side-burner is connected;
a shaft-rotation handle for rotating said side-burner toward said core rod by rotating said shaft;
a slide base, to which said shaft and said shaft-rotation handle are connected;
a ball screw for moving said slide base along a longitudinal direction of said core rod; and
a horizontal-movement handle which rotates said ball screw to move said slide base along a longitudinal direction of said core rod.

13. An apparatus for manufacturing a glass base material, which is a base material of an optical fiber, said glass base material having a core rod as an central axis, comprising:
a burner that hydrolyzes a gas material, which is a base material of said glass base material, into glass particles and accumulates said glass particles around said core rod to form said glass base material;
a chamber which accommodates said core rod and said burner;
an air vent formed on a bottom sidewall of said chamber to intake a cleaning gas for cleaning inside said chamber;
a filter formed inside said chamber, said filter located lower than said burner and higher than said air vent for regulating a flow speed distribution of said cleaning gas that flows from said air vent; and
an air-regulating-plate formed inside said chamber, said air-regulating-plate located lower than said burner and higher than said air vent and having a plurality of holes to regulate a direction of a flow of said cleaning gas that flows from said air vent.

14. An apparatus as claimed in claim 13, wherein said air-regulating-plate is formed on an upper side of said filter in said chamber.

15. An apparatus as claimed in claim 13, wherein said filter and said air regulating plate are located horizontally parallel to longitudinal direction of said core rod.

16. An apparatus as claimed in claim 14, wherein each of said filter and said air-regulating-plate covers all over a bottom face of said chamber.

17. An apparatus as claimed in claim 13, further comprising an exhaustion vent formed on a top of said chamber along a longitudinal direction of said core rod for exhausting said cleaning gas existing inside said chamber.

18. An apparatus as claimed in claim 13, wherein a distance L1 between a bottom surface of said glass base material and said air-regulating-plate is substantially 140 mm or greater.

19. An apparatus as claimed in claim 13, wherein a distance L1 between a bottom surface of said glass base material and said air-regulating-plate is substantially 1.25 D or greater when there is a relationship of 1.25 D≧140 mm where D is a diameter of a finished said glass base material.

20. An apparatus as claimed in claim 13, wherein a distance L2 between said air-regulating-plate and said filter has a relationship of 0≦L2/D≦1.0 where D is a diameter of a finished said glass base material.

21. An apparatus for manufacturing a glass base material, which is a base material of an optical fiber, said glass base material having a core rod as a central axis, comprising:
a burner that hydrolyzes a gas material, which is a base material of said glass base material, into glass particles and accumulates said glass particles around said core rod to form said glass base material;
a chamber installed on a floor, said chamber accommodating said core rod and said burner; and
a supporting unit formed on a bottom face of said chamber and contacting with said floor for supporting said chamber, said supporting unit comprising a fixed leg fixed on said floor and a plurality of movable legs which are movable with respect to said floor.

22. An apparatus as claimed in claim 21, wherein said fixed leg is disposed on said chamber on a center line thereof in at least one of the longitudinal direction and the widthwise direction.

23. An apparatus as claimed in claim 21, wherein said fixed leg is disposed on said chamber except on a corner of said chamber.

24. An apparatus as claimed in claim 21, further comprising: a core-rod-rotation unit for rotating said core rod around a central axis of said core rod, and said core-rod-rotation unit being provided outside said chamber.

25. A method for manufacturing a glass base material, which is a base material of an optical fiber, said glass base material having a core rod as a central axis, comprising:
hydrolyzing a gas material, which is a base material of said glass base material, into glass particles;
accumulating said glass particles around said core rod to form said glass base material;
intaking a cleaning gas into a chamber;
regulating a flow speed distribution of said cleaning gas that flows into said chamber by a filter; and
regulating a direction of a flow of said cleaning gas that passes through said filter.

26. An apparatus as claimed in claim 25, wherein said regulating said flow speed distribution and said regulating said direction of said flow regulates said flow of said cleaning gas to be a laminar flow.

27. An apparatus as claimed in claim 25, further comprising exhausting said cleaning gas from said chamber.
